(19) United States
(12) Patent Application Publication
(10) Pub. No.: US 2003/0074439 A1
(43) Pub. Date: Apr. 17, 2003

(54) Systems and methods for providing off-line decision support for correlation analysis

(75) Inventors: Genady Grabarnik, Briarcliff Manor, NY (US); Joseph L. Hellerstein, Ossining, NY (US); Sheng Ma, Briarcliff Manor, NY (US); Chang-Shing Perng, Bedford Hills, NY (US)

Correspondence Address: Ryan, Mason & Lewis, LLP, 90 Forest Avenue, Locust Valley, NY, 11560, US

(73) Assignee: International Business Machines Corporation, Armonk, NY

(21) Appl. No.: 09/976,540

(22) Filed: Oct. 12, 2001

(51) Int. Cl. G06F 15/173; G09G 5/00

(52) U.S. Cl. 709/224; 345/736; 706/909

(57) ABSTRACT

Techniques are provided for decision support for event management, both to support operational problem determination and to validate/construct correlation rules. The system comprises a set of tools for the analysis of events as a mechanism to construct and validate correlation rules. The methods describe how to use these tools for several decision support processes.

### FIELD OF THE INVENTION

The present invention relates generally to management of distributed systems and, more particularly, to techniques for visualizing and analyzing events, as well as constructing correlation rules.

### BACKGROUND OF THE INVENTION

As networked systems and applications became increasingly critical to the success of a business, effectively managing networked systems and applications becomes extremely important. In order to monitor networked systems and applications, a system manager (or a user) needs to monitor critical activities of systems and applications.

The most widely used approach to manage operational systems is to monitor their state and take actions when undesirable states occur or seem likely to occur. State transitions are typically signaled by an event message. Event messages are sent to an event management execution system (EMES) that parses these messages and takes appropriate action. In particular, an EMES contains components that analyze events, especially a correlation engine (so named because it correlates events from many sources in order to determine the action to take) or related techniques such as state machines and code books, e.g., as in U.S. Pat. No. 5,661,668 issued to Yemini et al. on Aug. 26, 1997 and entitled “Apparatus and Method for Analyzing and Correlating Events in a System Using a Causality Matrix,” the disclosure of which is incorporated by reference herein.

As is known, correlation engines interpret rules (or related representations of operational knowledge) that express: (a) a situation of interest (typically in the form of an event pattern); and (b) an action to take. Such an architecture is described in detail in K. R. Milliken et al., “YES/MVS and the Automation of Operations for Large Computer Complexes,” IBM Systems Journal, vol. 25, no. 2, 1986, the disclosure of which is incorporated by reference herein.

To illustrate the foregoing, examples of events in routers are “cold start,” “router port down” and “link up.” An example of a rule would be:

If two “port down” events occur on a router, then notify the operations staff. The motivation for this rule is that the availability of the router is in danger if two “port down” events occur. That is, it is very likely that a severe event will occur, such as a “cold start” (which is sent after a router fails). Thus, we can validate a rule by determining if the pattern it specifies in its if-part precedes a state change of interest, where the latter is indicated by a severe event or another event of interest.

There are at least two shortcomings with the existing art. First, existing EMESs provide very little in the way of visualization and analysis of event data, even though event data often contains information vital to problem detection, diagnosis, and resolution. For example, Tivoli's Enterprise Console provides a tabular view of event data that is color-coded by severity. While events can be sorted in many ways, patterns are difficult to detect (e.g., repetition of “port-down” every 10 seconds). Computer Associates' UniCenter product provides a three dimensional view of network elements and links this to event data. While this is very effective at discovering topology-based patterns, it is ineffective at discovering other relationships (e.g., errors caused by a new release of a software product).

Second, existing art provides little help in constructing correlation rules, something referred to in accordance with the invention as off-line decision support. Indeed, constructing and maintaining correlation rules is one of the most fundamental impediments to more effective event management. Many techniques have been used to reduce syntactic errors in authoring correlation rules. However, none of these systems provide a way to validate a proposed set of rules or extend existing rules. In particular, it would be desirable to verify that the event pattern specified in the rule does in fact anticipate a state change of importance.

### SUMMARY OF THE INVENTION

The present invention provides techniques for visualizing and analyzing events, and for constructing correlation rules. The techniques comprise the off-line use of various tools for performing and/or assisting in such visualization, analysis, and construction tasks. It is to be understood that the term “off-line” is meant to refer to the fact that these tools are preferably employed in non-real-time situations, i.e., performing visualizing, analyzing, and constructing tasks in accordance with historical or previously obtained and stored event data. However, the decision support techniques of the invention may be adapted for use in on-line or real-time situations.

In one aspect of the invention, a computer-based technique for providing decision support to an analyst in accordance with an event management system which manages a network with one or more computing devices, comprises the following steps. The technique comprises automatically analyzing data representing past events associated with the network of computing devices being managed by the event management system. Automated analysis comprises generation of one or more visualizations of one or more portions of the past event data and discovery of one or more patterns in the past event data. The technique also comprises automatically managing rules. Automated rule management comprises construction and validation of one or more rules formed in accordance with the automated analysis of the past event data. The past event data is preferably obtained from an event database and the one or more rules are provided to a rule database, the event database and the rule database being associated with an execution system of the event management system.

In a first embodiment, generation of the one or more visualizations of the one or more portions of the past event data may further comprise: (i) selecting a subset of the past event data from the event database; (ii) generating a visualization of the subset of past event data using a visualization tool; (iii) the analyst reviewing the visualization to determine whether there are any groupings of events that are of interest presented therein; and (iv) performing an appropriate action when an event grouping of interest is found.

In a second embodiment, discovery of the one or more patterns in the past event data may further comprise: (i) selecting a subset of the past event data from the event database; (ii) mining the subset of the past event data to discover the one or more patterns using a mining tool; (iii) generating a visualization of the one or more patterns using a visualization tool; (iv) the analyst reviewing the visualization to determine whether there are any patterns of interest presented therein; and (v) performing an appropriate action when a pattern of interest is found.

In a third embodiment, validation of the one or more rules may further comprise: (i) selecting a subset of the past event data from the event database; (ii) finding one or more instances of patterns expressed in terms of left-hand sides of rules; (iii) generating a visualization of the one or more pattern instances using a visualization tool; (iv) analyzing the left-hand sides of rules using a rule validation tool; (v) displaying results of the analysis operation; (vi) the analyst assessing analysis results; and (vii) marking the rules as one of validated and not validated based on the assessment by the analyst.

In a fourth embodiment, construction of the one or more rules may further comprise: (i) selecting a subset of the past event data from the event database; (ii) mining the subset of the past event data to discover the one or more patterns using a mining tool; (iii) assessing significance of the one or more patterns using a visualization tool; (iv) constructing the one or more rules from a selected subset of the one or more patterns using a rule construction tool; and (v) writing the one or more rules in the rule database.

Many benefits may be derived from use of the techniques of the present invention. By way of a first example, expert analysts are made more productive by tools that automatically discover patterns that, with existing art, would require considerable manual effort. By way of a second example, less experienced analysts are made more expert by using tools that automate rule construction so that the focus is on “rule critiquing” rather than “rule authoring.”

These and other objects, features and advantages of the present invention will become apparent from the following detailed description of illustrative embodiments thereof, which is to be read in connection with the accompanying drawings.

### BRIEF DESCRIPTION OF THE DRAWINGS

FIG. 1 is a block diagram illustrating an overall architecture in which an off-line decision support system for event management according to an embodiment of the present invention may operate;

FIG. 2 is a block diagram illustrating components of an event management execution system and an off-line event management decision support system according to an embodiment of the present invention;

FIG. 3 is a flow diagram illustrating a methodology of performing event analysis with visualization according to an embodiment of the present invention;

FIG. 4 is a flow diagram illustrating a methodology of performing event analysis with mining according to an embodiment of the present invention;

FIG. 5 is a flow diagram illustrating a methodology of performing rule validation according to an embodiment of the present invention;

FIG. 6 is a flow diagram illustrating a methodology of performing rule construction according to an embodiment of the present invention; and

FIG. 7 is a block diagram illustrating a generalized hardware architecture of a computer system suitable for implementing an off-line decision support system for use in event management according to the present invention.

### DETAILED DESCRIPTION OF PREFERRED EMBODIMENTS

The present invention will be described below in the context of an exemplary event management system architecture. However, it is to be understood that the invention is not limited to use with a particular event management system architecture but is rather more generally applicable for use in accordance with any event management systems in which it is desirable to provide decision support for visualizing and analyzing events and for constructing correlation rules.

More particularly, in accordance with the invention, an illustrative off-line event management decision support system (EMDSS) for use in managing a distributed computing system will be described below. It is to be understood that the techniques employed by the decision support system interact with an event management execution system (EMES) in two ways. First, the decision support system reads events stored in an event database of the EMES. Second, the decision support system reads and writes correlation rules in a rule database of the EMES.

The event management decision support system of the invention is structured as a set of tools that are partitioned into two categories. The first category, called the event analysis tools, provide visualization and mining for events in the event database.

One group of event analysis tools, which are referred to collectively herein as an “Event Browser,” provides visualizations such as scatter plots and three dimensional graphs to show relationships between event type, time, and event source, as well as between other variables. A preferred visualization methodology which may be employed is described in the U.S. patent application identified by Ser. No. 09/359,874 filed on Jul. 27, 1999 and entitled “Systems and Methods for Exploratory Analysis of Data for Event Management,” the disclosure of which is incorporated by reference herein. One of ordinary skill in the art will realize various other methods for providing event data visualizations that may be employed in accordance with the present invention, e.g., the visualization methodologies described in U.S. Pat. No. 5,874,955 issued to Rogowitz et al. on Feb. 23, 1999 and entitled “Interactive Rule Based System with Selection Feedback that Parameterizes Rules to Constrain Choices for Multiple Operations,” the disclosure of which is incorporated by reference herein. However, the invention is not limited to these examples.

A second set of event analysis tools are collectively referred to herein as an “Event Miner.” These tools provide mechanisms for discovering or mining patterns in the event data, such as mutually dependent patterns, periodic patterns, and others. Preferred event mining techniques which may be employed are described in the U.S. patent application identified by Ser. No. 09/567,445 filed on May 8, 2000 and entitled “Systems and Methods for Authoring and Executing Operational Policies that Use Event Rates,” the U.S. patent application identified by Ser. No. 09/739,432 filed on Dec. 18, 2000 and entitled “Systems and Methods for Discovering Partially Periodic Event Patterns,” the U.S. patent application identified by Ser. No. 09/918,253 filed on Jul. 30, 2001 and entitled “Systems and Methods for Discovering Mutual Dependence Patterns,” and the U.S. patent application identified by attorney docket no. YOR920010747US1 filed concurrently herewith and entitled: “Systems and Methods for Pairwise Analysis of Event Data,” the disclosures of which are incorporated by reference herein. One of ordinary skill in the art will realize various other methods for mining event data to discover patterns that may be employed in accordance with the present invention, e.g., H. Mannila et al., “Discovery of Frequent Episodes in Event Sequences,” Data Mining and Knowledge Discovery, 1(3), 1997; R. Agrawal et al., “Mining Association Rules Between Sets of Items in Large Databases,” Proc. of VLDB, pp. 207-216, 1993; and R. Srikant et al., “Mining Sequential Patterns: Generalizations and Performance Improvements,” Proc. of the Fifth Int'l Conference on Extending Database Technology (EDBT), Avignon, France, 1996, the disclosures of which are incorporated by reference herein. However, the invention is not limited to these examples.

The second category of tools comprise what is referred to herein as a “Rule Wizard.” Included here are tools for rule validation (referred to herein as a “Rule Validator”) based on statistical techniques (e.g., occurrence counts) as well as for rule construction (referred to herein as a “Rule Constructor”). Preferred methodologies that may be employed in accordance with the present invention for validating and constructing rules are described in the U.S. patent application identified by attorney docket no. YOR920010748US1 filed concurrently herewith and entitled “Systems and Methods for Validation, Completion and Construction of Event Relationship Networks,” the U.S. patent application identified by Ser. No. 09/731,937 filed on Dec. 7, 2000 and entitled “Method and System for Machine-Aided Rule Construction for Event Management,” and the U.S. patent application identified by Ser. No. 09/849,565 filed on May, 4, 2001 and entitled “System and Method for Systematic Construction of Correlation Rules for Event Management,” the disclosures of which are incorporated by reference herein. One of ordinary skill in the art will realize various other methods for providing rule construction that may be employed in accordance with the present invention, e.g., the above-mentioned U.S. Pat. No. 5,661,668 issued to Yemini et al., the above-mentioned YES/MVS system, and an event correlation system proposed by Computer Associates called “Neugents.” However, the invention is not limited to these examples.

As will be explained in detail below in the context of the illustrative figures, the methodologies of the present invention provide several ways in which such tools are used in operational settings. For example, one method addresses how the Event Browser tools are used to visualize event data to discover patterns that are actionable. A second method teaches how to automate the discovery of actionable patterns by using the Event Miner and Event Browser tools. A third method describes how to validate correlation rules using the Event Browser and Rule Validator tools. A fourth method addresses how to construct correlation rules using the Event Miner, Event Browser and Rule Constructor tools.

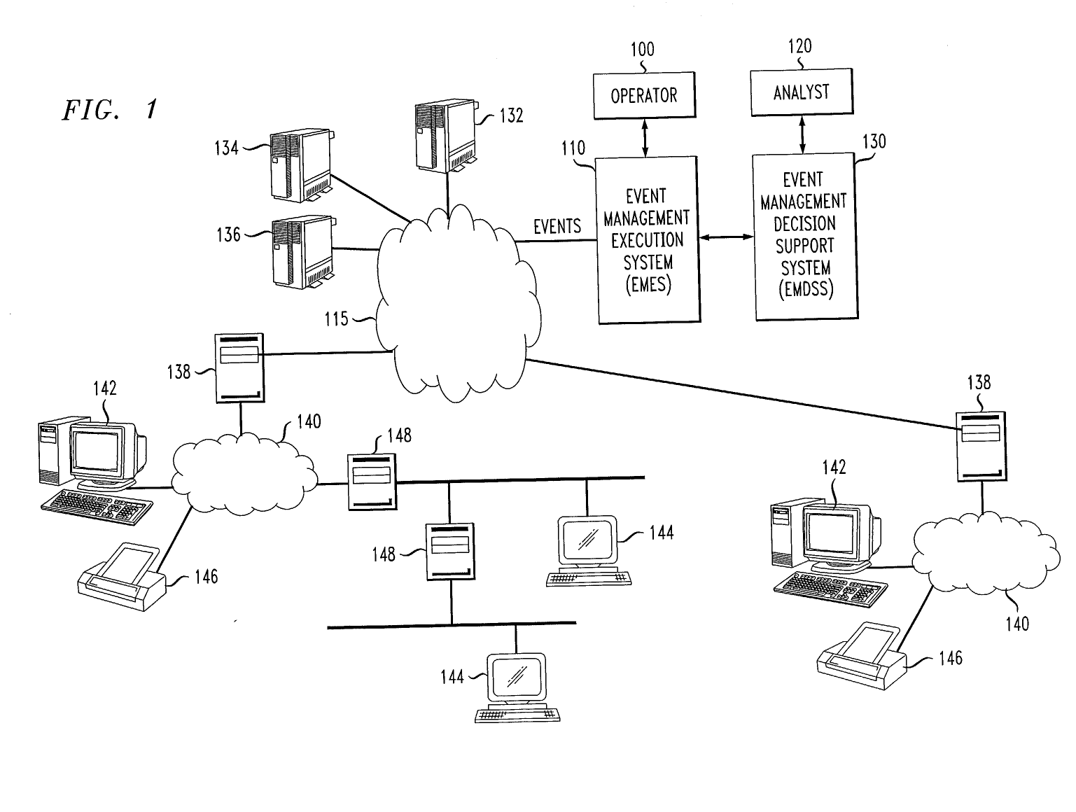

Referring initially to FIG. 1, a block diagram illustrates an overall architecture in which an off-line event management decision support system according to an embodiment of the present invention may operate. Generally, FIG. 1 shows an event management decision support system (EMDSS) according to the invention operating in association with an event management execution system (EMES) in the context of an exemplary network of distributed computing devices with which the present invention may be employed.

Thus, as depicted in FIG. 1, an operator 100 receives alerts and initiates responding actions based on interactions with the event management execution system 110. The event management execution system 110 receives events generated by computing devices of various types. The computing devices are connected to the event management execution system 110 via a network 115. The network 115 may be, for example, a public network (e.g., Internet), a private network, and/or some other suitable network. The computing devices may include, for example, file servers 132, name servers 134, mail servers 136, routers 138, wherein the routers provide connection to the network 115 for work stations 142 and 144, print servers 146 and hub 148 through subnetworks 140.

The event management execution system 110 updates an event database (Event DB) associated therewith with newly received events and reads this database to do event correlation based on a rule database (Rule DB) associated therewith. Advantageously, as will be illustrated below, an analyst 120 uses the event management decision support system 130 of the present invention off-line to visualize and analyze the stored event data and to develop and validate correlation rules to be used by the event management execution system 110. Doing so requires reading historical event data in the Event DB and writing to the Rule DB of the event management execution system 110. Detailed explanations of the components of the event management execution system 110, and the off-line event management decision support system 130 of the present invention, will be provided below.

It is to be understood that the operator 100 and the analyst 120 are individuals who may directly interact with the event management execution system 110 and the event management decision support system 130, respectively, in association with the computer system(s) upon which the event management execution system 110 and the event management decision support system 130 reside and execute, or they may have their own dedicated computer systems that are in communication with the event management execution system 110 and the event management decision support system 130, respectively. It is also to be understood that the event management execution system 110 and the event management decision support system 130 may cumulatively be referred to as an event management system or EMS.

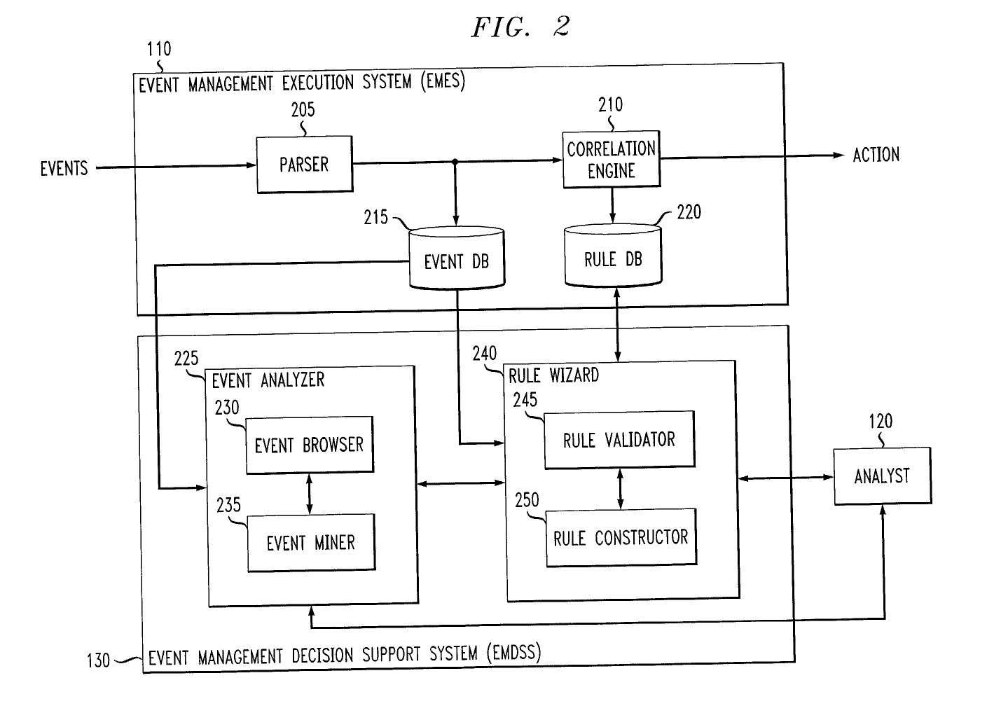

Referring now to FIG. 2, a block diagram illustrates components of an event management execution system and an off-line event management decision support system according to an embodiment of the present invention. As shown in FIG. 2, the event management execution system 110 comprises an event parser 205, a correlation engine 210, an event database (Event DB) 215, and a rule database (Rule DB) 220. Further, as shown in FIG. 2, the off-line event management decision support system 130 comprises an event analysis module 225 (referred to as the “Event Analyzer”) which, itself, comprises an event visualization module 230 (referred to as the “Event Browser”) and an event mining module 235 (referred to as the “Event Miner”). The decision support system 130 further comprises a rule management module 240 (referred to as the “Rule Wizard”) which, itself, comprises a rule validation module 245 (referred to as the “Rule Validator”) and a rule construction module 250 (referred to as the “Rule Constructor”).

Events arrive at the event management execution system 110 from the devices of the distributed network shown in FIG. 1. The events are parsed by parser 205 and placed into an event database 215 that has standard database management software (such as Standard Query Language or SQL command access). Further, these parsed events are input to the correlation engine 210 that uses rules in the rule database 220 to determine actions to take.

In general, in an off-line mode, the event analyzer 225 of the event management decision support system inputs events from the event database that are used by the event browser 230 and the event miner 235. The event miner interacts with the analyst 120 to aid in operational problem solving (e.g., problem determination) by discovering patterns in the event data that may be of interest to the analyst. The event miner also interacts with the event browser, which provides mechanisms for visualizing, for the analyst, results of pattern discovery and rule analysis. The rule wizard 240 of the event management decision support system provides mechanisms for validating and extending the rule database 220. The rule validator 245 component of the rule wizard determines if rules are consistent with the event data. The rule constructor component 250 provides mechanisms for constructing new rules based on event patterns mined by the event miner. In particular, the rule constructor translates event patterns into the syntax used by rules in the rule database 220 (e.g., using data mining association rules).

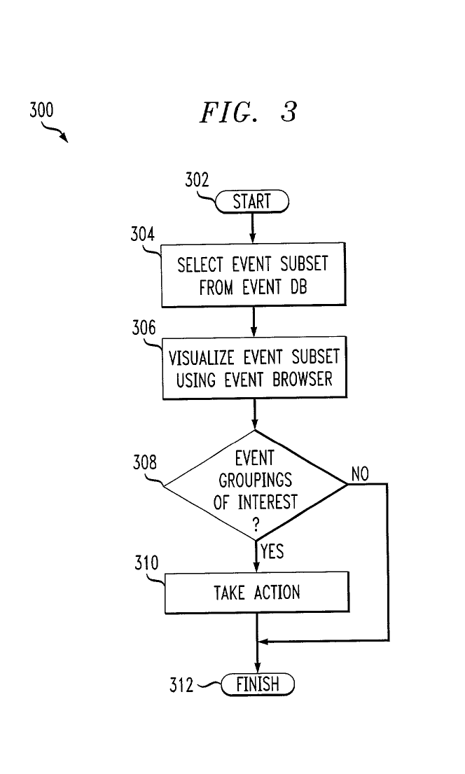

It is to be appreciated that the detailed operations performed by each tool described above, i.e., the event browser and event miner of the event analyzer tool set and the rule validator and rule constructor of the rule wizard tool set, depend on the particular methodologies employed therein. For example, the event browser may provide scatter plots as visualizations of event data, the event miner may discover mutually dependent patterns, the rule constructor and validator may construct rules using learning algorithms. Various methodologies and implementations were given above for preferred embodiments of such tools of the decision support system of the invention, as well as for exemplary alternative embodiments. Since the tools could therefore be embodied as those preferred techniques or by alternative techniques, the specific techniques are not critical to the invention and therefore are not necessarily detailed herein. Thus, the remaining portions of the detailed description, with regard to FIGS. 3-6, focus on the inventive interaction of the various tools in providing an analyst with off-line support in visualizing and analyzing event data and in constructing and validating rules for use by a correlation engine of an event management execution system.

Referring now to FIG. 3, a flow diagram illustrates a methodology of performing event analysis with visualization according to an embodiment of the present invention. More particularly, FIG. 3 depicts a process 300 illustrating how the Event Browser tools are used to visualize event data to discover event groupings that are actionable. The process begins at block 302. In step 304, a subset of events in the event database is selected using standard database tools. In step 306, this event subset is visualized using the Event Browser 230. In step 308, in accordance with a review of the visualization, the analyst determines if there is an event grouping of interest. In step 310, an action is taken for those event groups of interest. Examples of actions include e-mailing an administrator, opening a trouble ticket, and resetting a device. Note that this method is repeated for each grouping discovered. If there are no groupings of interest, the process ends at block 312.

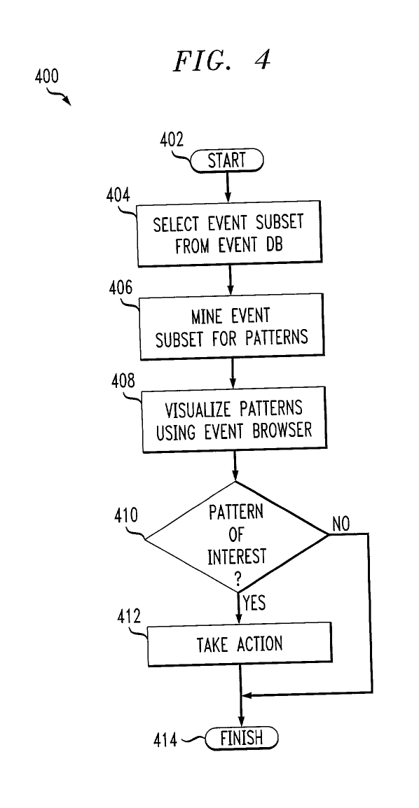

Referring now to FIG. 4, a flow diagram illustrates a methodology of performing event analysis with mining according to an embodiment of the present invention. More particularly, FIG. 4 depicts a process 400 illustrating automated discovery of actionable patterns using the Event Miner and Event Browser tools. The process begins at block 402. In step 404, a subset of events in the event database is selected. In step 406, the Event Miner 235 is applied to this subset to discover patterns. In step 408, the Event Browser 230 is used to visualize the pattern results. In step 410, in accordance with a review of the visualization, the analyst determines if there is a mined pattern of interest. In step 412, an action is taken for those patterns of interest, such as those actions described above for FIG. 3. Note that this method is repeated for each pattern discovered. If there are no patterns of interest, the process ends at block 414.

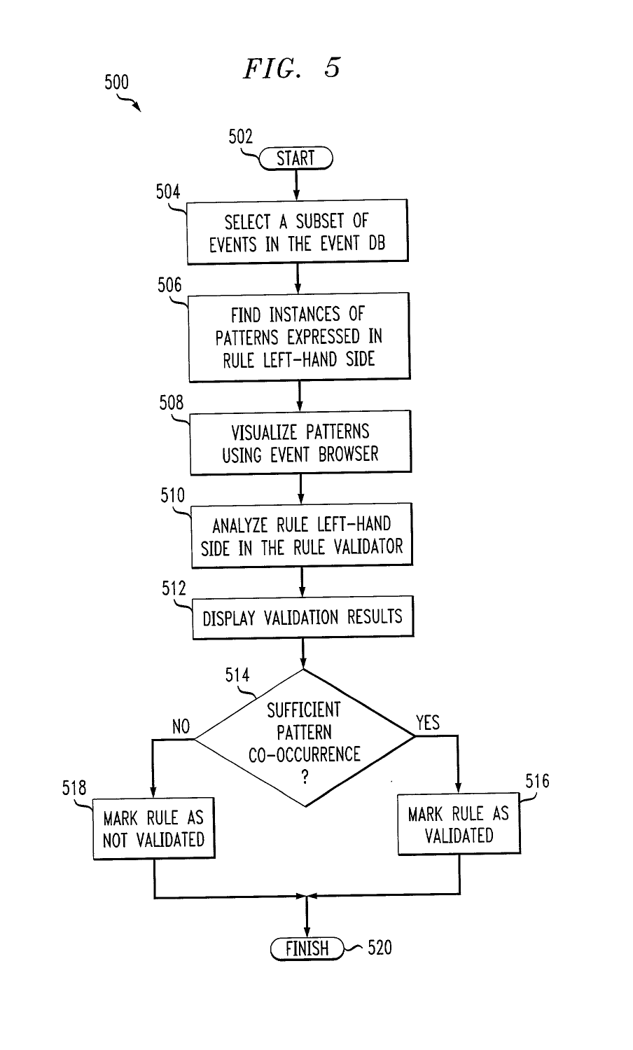

Referring now to FIG. 5, a flow diagram illustrates a methodology of performing rule validation according to an embodiment of the present invention. More particularly, FIG. 5 depicts a process 500 illustrating the validation of correlation rules using the Event Browser and Rule Validator tools. The process begins at block 502. In step 504, a subset of events in the event database is selected to use in the rule validation. In step 506, instances of patterns to be expressed in left-hand side of a rule are found. As mentioned previously, the left-hand side of a rule is the “if” portion (e.g., if event A at host B occurs, then take action C). Such pattern instances may be identified using standard SQL interfaces. In step 508, these patterns are visualized using the Event Browser 230. In step 510, the Rule Validator 245 is used to determine if the patterns (which represent the proposed rule left-hand sides) so identified are leading indicators of the occurrence of a severe event. In step 512, the results of this analysis are displayed. If it is found, in step 514, that there is a sufficient co-occurrence of the pattern with a severe event (or other indication of state change), then in step 516 the rule is marked as validated. Otherwise, in step 518, the rule is marked as not validated. Note that this method is repeated for each pattern discovered. The process ends at block 520.

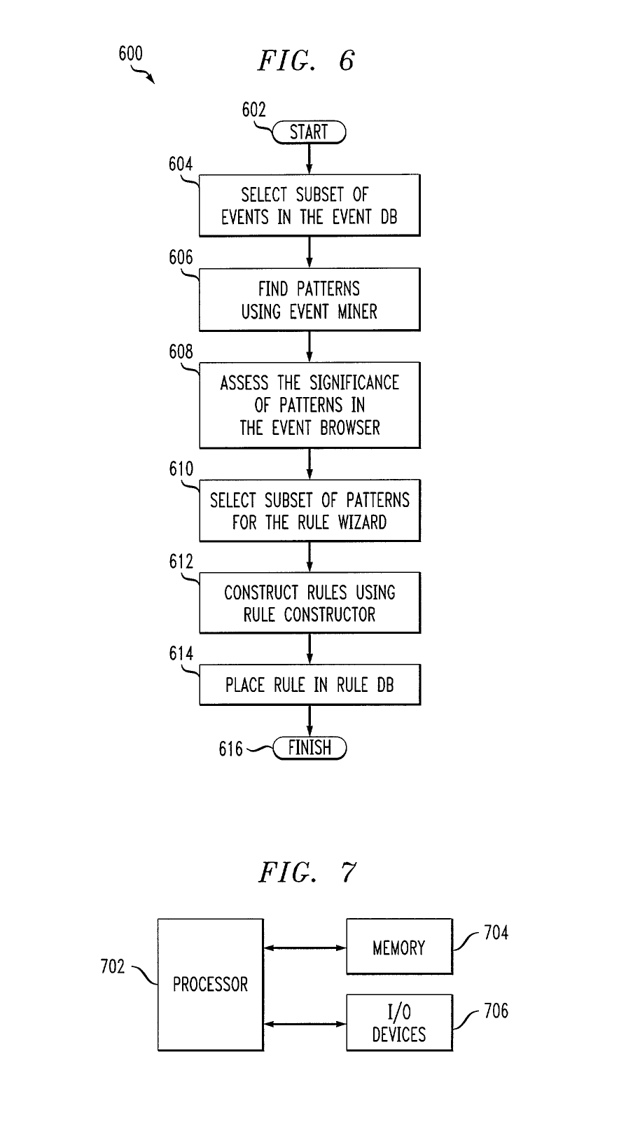

Referring now to FIG. 6, a flow diagram illustrates a methodology of performing rule construction according to an embodiment of the present invention. More particularly, FIG. 6 depicts a process 600 illustrating construction of correlation rules using the Event Miner, Event Browser and Rule Constructor tools. The process begins at block 602. In step 604, a subset of events in the event database is selected to use in the rule construction. In step 606, the Event Miner 235 is used to discover patterns in the event subset selected. In step 608, the significance of these patterns is assessed by an analyst using the Event Browser 230. Assessment of significance depends, in part, on the patterns being able to anticipate the occurrence of a state change of importance. In step 610, the analyst selects a subset of these patterns as input to the Rule Wizard 245. In step 612, the Rule Constructor 250 is employed to express a rule left-hand side and select an appropriate action. In step 614, the resulting rule is placed in the rule database. Note that this method is repeated for each pattern discovered. The process ends at block 616.

Rule validation is desirable, for example, if site administrators have special insight into the interpretation of events and wish to construct rules based on these insights. Validation provides a technique to assess the significance and correctness of rules proposed in this way.

Referring now to FIG. 7, a block diagram is shown illustrating a generalized hardware architecture of a computer system suitable for implementing the various functional components/modules of an off-line event management decision support system 130 as depicted in the figures and explained in detail herein. It is to be understood that the individual components of the event management decision support system may be implemented on one such computer system, or on more than one separate such computer system. Also, individual components of the system may be implemented on separate such computer systems. It is also to be appreciated that the event management execution system 110 may be implemented on one or more such computer systems.

As shown, the computer system may be implemented in accordance with a processor 702, a memory 704 and I/O devices 706. It is to be appreciated that the term “processor” as used herein is intended to include any processing device, such as, for example, one that includes a CPU (central processing unit) and/or other processing circuitry. The term “memory” as used herein is intended to include memory associated with a processor or CPU, such as, for example, RAM, ROM, a fixed memory device (e.g., hard drive), a removable memory device (e.g., diskette), flash memory, etc. In addition, the term “input/output devices” or “I/O devices” as used herein is intended to include, for example, one or more input devices (e.g., keyboard, mouse, etc.) for entering data to the processing unit, and/or one or more output devices (e.g., CRT display, printer, etc.) for presenting results associated with the processing unit. For example, user interfaces of the system employed by an analyst (e.g., to review visualizations and/or other processing results, select events, enter queries, etc.) may be realized through such I/O devices. It is also to be understood that the term “processor” may refer to more than one processing device and that various elements associated with a processing device may be shared by other processing devices.

Accordingly, software components including instructions or code for performing the methodologies of the invention, as described herein, may be stored in one or more of the associated memory devices (e.g., ROM, fixed or removable memory) as an article of manufacture and, when ready to be utilized, loaded in part or in whole (e.g., into RAM) and executed by a CPU.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. Apparatus for providing decision support to an analyst in accordance with an event management system which manages a network with one or more computing devices, the apparatus comprising:
at least one processor operative to perform: (i) an automated analysis of data representing past events associated with the network of computing devices being managed by the event management system, the automated analysis comprising generation of one or more visualizations of one or more portions of the past event data and discovery of one or more patterns in the past event data; and (ii) automated rule management comprising construction and validation of one or more rules formed in accordance with the automated analysis of the past event data; and
memory, coupled to the at least one processor, which stores at least a portion of results associated with the automated event analysis and rule management operations.

2. The apparatus of claim 1, wherein the past event data is obtained from an event database and the one or more rules are provided to a rule database, the event database and the rule database being associated with an execution system of the event management system.

3. The apparatus of claim 2, wherein generation of the one or more visualizations of the one or more portions of the past event data further comprises:
selecting a subset of the past event data from the event database;
generating a visualization of the subset of past event data using a visualization tool;
the analyst reviewing the visualization to determine whether there are any groupings of events that are of interest presented therein; and
performing an appropriate action when an event grouping of interest is found.

4. The apparatus of claim 2, wherein discovery of the one or more patterns in the past event data further comprises:
selecting a subset of the past event data from the event database;
mining the subset of the past event data to discover the one or more patterns using a mining tool;
generating a visualization of the one or more patterns using a visualization tool;
the analyst reviewing the visualization to determine whether there are any patterns of interest presented therein; and
performing an appropriate action when a pattern of interest is found.

5. The apparatus of claim 2, wherein validation of the one or more rules farther comprises:
selecting a subset of the past event data from the event database;
finding one or more instances of patterns expressed in terms of left-hand sides of rules;
generating a visualization of the one or more pattern instances using a visualization tool;
analyzing the left-hand sides of rules using a rule validation tool;
displaying results of the analysis operation;
the analyst assessing analysis results; and
marking the rules as one of validated and not validated based on the assessment by the analyst.

6. The apparatus of claim 2, wherein construction of the one or more rules further comprises:
selecting a subset of the past event data from the event database;
mining the subset of the past event data to discover the one or more patterns using a mining tool;
assessing significance of the one or more patterns using a visualization tool;
constructing the one or more rules from a selected subset of the one or more patterns using a rule construction tool; and
writing the one or more rules in the rule database.

7. A computer-based method of providing decision support to an analyst in accordance with an event management system which manages a network with one or more computing devices, the method comprising the steps of:
automatically analyzing data representing past events associated with the network of computing devices being managed by the event management system, the automated analysis comprising generation of one or more visualizations of one or more portions of the past event data and discovery of one or more patterns in the past event data; and
automatically managing rules, the automated rule management comprising construction and validation of one or more rules formed in accordance with the automated analysis of the past event data.

8. The method of claim 7, wherein the past event data is obtained from an event database and the one or more rules are provided to a rule database, the event database and the rule database being associated with an execution system of the event management system.

9. The method of claim 7, wherein generation of the one or more visualizations of the one or more portions of the past event data further comprises:
selecting a subset of the past event data from the event database;
generating a visualization of the subset of past event data using a visualization tool;
the analyst reviewing the visualization to determine whether there are any groupings of events that are of interest presented therein; and
performing an appropriate action when an event grouping of interest is found.

10. The method of claim 7, wherein discovery of the one or more patterns in the past event data further comprises:
selecting a subset of the past event data from the event database;
mining the subset of the past event data to discover the one or more patterns using a mining tool;
generating a visualization of the one or more patterns using a visualization tool;
the analyst reviewing the visualization to determine whether there are any patterns of interest presented therein; and
performing an appropriate action when a pattern of interest is found.

11. The method of claim 7, wherein validation of the one or more rules further comprises:
selecting a subset of the past event data from the event database;
finding one or more instances of patterns expressed in terms of left-hand sides of rules;
generating a visualization of the one or more pattern instances using a visualization tool;
analyzing the left-hand sides of rules using a rule validation tool;
displaying results of the analysis operation;
the analyst assessing analysis results; and
marking the rules as one of validated and not validated based on the assessment by the analyst.

12. The method of claim 7, wherein construction of the one or more rules further comprises:
selecting a subset of the past event data from the event database;
mining the subset of the past event data to discover the one or more patterns using a mining tool;
assessing significance of the one or more patterns using a visualization tool;
constructing the one or more rules from a selected subset of the one or more patterns using a rule construction tool; and
writing the one or more rules in the rule database.

13. An article of manufacture for providing decision support to an analyst in accordance with an event management system which manages a network with one or more computing devices, the article comprising a machine readable medium containing one or more programs which when executed implement the steps of:
automatically analyzing data representing past events associated with the network of computing devices being managed by the event management system, the automated analysis comprising generation of one or more visualizations of one or more portions of the past event data and discovery of one or more patterns in the past event data; and
automatically managing rules, the automated rule management comprising construction and validation of one or more rules formed in accordance with the automated analysis of the past event data.

14. The article of claim 13, wherein the past event data is obtained from an event database and the one or more rules are provided to a rule database, the event database and the rule database being associated with an execution system of the event management system.

15. Apparatus for providing decision support to an analyst in accordance with an event management system which manages a network with one or more computing devices, the apparatus comprising:
first processing means for performing an automated analysis of data representing past events associated with the network of computing devices being managed by the event management system, the automated analysis comprising generation of one or more visualizations of one or more portions of the past event data and discovery of one or more patterns in the past event data;
second processing means for performing automated rule management comprising construction and validation of one or more rules formed in accordance with the automated analysis of the past event data; and
memory means, coupled to the first and second processing means, for storing at least a portion of results associated with the automated event analysis and rule management operations.

16. The apparatus of claim 15, wherein the past event data is obtained from an event database and the one or more rules are provided to a rule database, the event database and the rule database being associated with an execution system of the event management system.

17. An event management decision support system for providing decision support to an analyst in accordance with an event management system which manages a network with one or more computing devices, the system comprising:
one or more data analysis tools for automatically analyzing, in an off-line condition, data representing events associated with the network of computing devices being managed by the event management system, the automated analysis comprising generation of one or more visualizations of one or more portions of the event data and discovery of one or more patterns in the event data; and
one or more rule management tools for automatically managing rules in an off-line condition, the automated rule management comprising construction and validation of one or more rules formed in accordance with the automated analysis of the event data.

18. The system of claim 17, wherein the event data is obtained from an event database and the one or more rules are provided to a rule database, the event database and the rule database being associated with an execution system of the event management system.
